(19) United States
(12) Patent Application Publication
(10) Pub. No.: US 2025/0376324 A1
(43) Pub. Date: Dec. 11, 2025

(54) AN AUTOMATED STORAGE AND RETRIEVAL SYSTEM HAVING A CONTAINER TRANSFER APPARATUS, AND A METHOD THEREOF

(71) Applicant: AutoStore Technology AS, Nedre Vats (NO)

(72) Inventors: Trond Austrheim, Etne (NO); Ole Andreas Haddeland, Avaldsnes (NO)

(21) Appl. No.: 18/875,213

(22) PCT Filed: Aug. 11, 2023
(86) PCT No.: PCT/EP2023/072342

§ 371 Date: Dec. 16, 2024

(30) Foreign Application Priority Data
Aug. 12, 2022 (NO) 20220878

(51) Int. Cl. B65G 1/04

(52) U.S. Cl. CPC B65G 1/0464; B65G 1/0478; B65G 1/0492; B65G 2201/0235

(57) ABSTRACT

The invention concerns an automated storage and retrieval system comprising a first space, a second space, a wall separating the storage system into the first space and the second space, a container transfer passage extending through the wall and a container carrier arranged within the passage for transport of at least one storage container therethrough. The container transfer passage is suitable for holding and transferring storage containers between the first space and the second space and extends below a level of the rail system. The invention also concerns a container transfer apparatus and a method using the system and the apparatus.

### TECHNICAL FIELD

The present invention relates to an automated storage and retrieval system, a container transfer apparatus using such a system and a method for transport of storage containers via the container transfer apparatus.

### BACKGROUND AND PRIOR ART

FIG. 1 discloses a prior art automated storage and retrieval system 1 with a framework structure 100 and FIGS. 2, 3 and 4 disclose three different prior art container handling devices 200,300,400 suitable for operating on such a system 1.

The framework structure 100 comprises upright members 102 and a storage volume 104 comprising storage columns 105 arranged in rows between the upright members 102. In these storage columns 105, storage containers 106, also known as bins, are stacked one on top of one another to form stacks 107. The members 102 may typically be made of metal, e.g. extruded aluminum profiles.

The framework structure 100 of the automated storage and retrieval system 1 comprises a rail system 108 arranged across the top of the storage volume 104, on which rail system 108 a plurality of container handling devices 200,300,400 may be operated to raise bins 106 from, and lower bins 106 into, the storage columns 105, and also to transport the bins 106 above the storage columns 105. The rail system 108 comprises a first set of parallel rails 110 arranged to guide movement of the container handling devices 200,300,400 in a first direction X across the top of the frame structure 100, and a second set of parallel rails 111 arranged perpendicular to the first set of rails 110 to guide movement of the container handling devices 200,300,400 in a second direction Y which is perpendicular to the first direction X. Containers 106 stored in the columns 105 are accessed by the container handling devices 200,300,400 through access openings 112 in the rail system 108. The container handling devices 200,300,400 can move laterally above the storage columns 105, i.e. in a plane which is parallel to the horizontal X-Y plane.

The upright members 102 of the framework structure 100 may be used to guide the bins 106 during raising of the bins 106 out from and lowering of the bins 106 into the columns 105. The stacks 107 of bins 106 are typically self-supporting.

Each prior art container handling device 200,300,400 comprises a handling device body/vehicle body 201,301,401 and first and second sets of wheels 202a, 202b, 302a, 302b, 402a, 402b which enable the lateral movement of the container handling devices 200,300,400 in the X direction and in the Y direction, respectively. In FIGS. 2, 3 and 4 two wheels in each set are fully visible. The first set of wheels 202a, 302a, 402a is arranged to engage with two adjacent rails of the first set 110 of rails, and the second set of wheels 202b,302b,402b is arranged to engage with two adjacent rails of the second set 111 of rails. At least one of the sets of wheels 202a, 202b, 302a, 302b, 402a, 402b can be lifted and lowered, so that the first set of wheels 202a, 302a, 402a and/or the second set of wheels 202b,302b,402b can be engaged with the respective set of rails 110, 111 at any one time.

Each prior art container handling device 200,300,400 also comprises a lifting device 303,403 for vertical transportation of bins 106, e.g. raising a bin 106 from, and lowering a bin 106 into, a storage column 105. The lifting device 303,403 comprises one or more gripping/engaging devices 404 which are adapted to engage a bin 106, and which gripping/engaging devices 404 can be lowered from the vehicle 200,300,400 so that the position of the gripping/engaging devices 404 with respect to the vehicle 200,300,400 can be adjusted in a third direction Z which is orthogonal the first direction X and the second direction Y. The gripping device 404 of the container handling device/vehicle 400 in form of a plurality of claws is shown in FIG. 4. The lifting device of the container handling device 200 is located within the vehicle body 201 and is thus not shown.

Conventionally, and also for the purpose of this application, Z=1 identifies the uppermost layer available for bins below the rails 110, 111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of bins. Similarly, X=1 . . . n and Y=1 . . . n identifies the position of each storage column 105 in the horizontal plane. Consequently, as an example, and using the Cartesian coordinate system X, Y, Z indicated in FIG. 1, the bins identified as 106′ in FIG. 1 can be said to occupy storage position X=17, Y=1, Z=6. The container handling devices 200,300,400 can be said to travel in layer Z=0, and each storage column 105 can be identified by its X and Y coordinates. Thus, the bins shown in FIG. 1 extending above the rail system 108 are also said to be arranged in layer Z=0.

The storage volume of the framework structure 100 has often been referred to as a storage grid 104, where the possible storage positions within this storage volume 104 are referred to as storage cells. Each storage column may be identified by a position in an X- and Y-direction, while each storage cell may be identified by a container number in the X-, Y- and Z-direction.

Each prior art container handling device 200,300,400 comprises a storage compartment or space for receiving and stowing a bin 106 when transporting the bin 106 across the rail system 108. The storage space may comprise a cavity arranged internally within the vehicle body 201,301,401 as present in FIGS. 2 and 4 and as described in e.g. WO2015/193278A1 and WO2019/206487A1, the contents of which are incorporated herein by reference.

FIG. 3 shows an alternative configuration of a container handling device/vehicle 300 with a cantilever construction. Such a vehicle is described in detail in e.g. NO317366, the contents of which are also incorporated herein by reference.

The central cavity type vehicle 200 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling devices/vehicle 400 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails 110,111 with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y 25 direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where bins 106 are stored in stacks 107. However, some columns 105 may have other purposes. In FIG. 1, columns 119 and 120 are such special-purpose columns used by the container handling devices 200,300,400 to drop off and/or pick up bins 106 so that they can be transported to an access station (not shown) where the bins 106 can be accessed from outside of the framework structure 100 or transferred out of or into the framework structure 100. Within the art, such a location is normally referred to as a ‘port’ and the column in which the port is located may be referred to as a ‘port column’ 119, 120. The transportation to the access station may be in any direction, that is horizontal, tilted and/or vertical. For example, the bins 106 may be placed in a random or dedicated column 105 within the framework structure 100, then picked up by any container handling device and transported to a port column 119, 120 for further transportation to an access station. The transportation from the port to the access station may require movement along various different directions, by means such as delivery vehicles, trolleys or other transportation lines. Note that the term ‘tilted’ means transportation of bins 106 having a general transportation orientation somewhere between horizontal and vertical.

In FIG. 1, the first port column 119 may for example be a dedicated drop-off port column where the container handling devices 200,300,400 can drop off bins 106 to be transported to an access or a transfer station, and the second port column 120 may be a dedicated pick-up port column where the container handling devices 200,300,400 can pick up bins 106 that have been transported from an access or a transfer station.

The access station may typically be a picking or a stocking station where product items are removed from or positioned into the bins 106. In a picking or a stocking station, the bins 106 are normally not removed from the automated storage and retrieval system 1, but are returned into the framework structure 100 again once accessed. A port can also be used for transferring bins to another storage facility (e.g. to another framework structure or to another automated storage and retrieval system), to a transport vehicle (e.g. a train or a lorry), or to a production facility.

A conveyor system comprising conveyors is normally employed to transport the bins between the port columns 119,120 and the access station.

If the port columns 119,120 and the access station are located at different levels, the conveyor system may comprise a lift device with a vertical component for transporting the bins 106 vertically between the port column 119,120 and the access station.

The conveyor system may be arranged to transfer bins 106 between different framework structures, e.g. as is described in WO2014/075937A1, the contents of which are incorporated herein by reference.

When a bin 106 stored in one of the columns 105 disclosed in FIG. 1 is to be accessed, one of the container handling devices 200,300,400 is instructed to retrieve the target bin 106 from its position and transport it to the drop-off port column 119. This operation involves moving the container handling device 200,300,400 to a location above the storage column 105 in which the target bin 106 is positioned, retrieving the bin 106 from the storage column 105 using the container handling device's 200,300,400 lifting device, and transporting the bin 106 to the drop-off port column 119. If the target bin 106 is located deep within a stack 107, i.e. with one or a plurality of other bins 106 positioned above the target bin 106, the operation also involves temporarily moving the above-positioned bins prior to lifting the target bin 106 from the storage column 105. This step, which is sometimes referred to as “digging” within the art, may be performed with the same container handling device that is subsequently used for transporting the target bin to the drop-off port column 119, or with one or a plurality of other cooperating container handling devices. Alternatively, or in addition, the automated storage and retrieval system 1 may have container handling devices 200,300,400 specifically dedicated to the task of temporarily removing bins 106 from a storage column 105. Once the target bin 106 has been removed from the storage column 105, the temporarily removed bins 106 can be repositioned into the original storage column 105. However, the removed bins 106 may alternatively be relocated to other storage columns 105.

When a bin 106 is to be stored in one of the columns 105, one of the container handling devices 200,300,400 is instructed to pick up the bin 106 from the pick-up port column 120 and transport it to a location above the storage column 105 where it is to be stored. After any bins 106 positioned at or above the target position within the stack 107 have been removed, the container handling device 200,300,400 positions the bin 106 at the desired position. The removed bins 106 may then be lowered back into the storage column 105, or relocated to other storage columns 105.

For monitoring and controlling the automated storage and retrieval system 1, e.g. monitoring and controlling the location of respective bins 106 within the framework structure 100, the content of each bin 106; and the movement of the container handling devices 200,300,400 so that a desired bin 106 can be delivered to the desired location at the desired time without the container handling devices 200,300,400 colliding with each other, the automated storage and retrieval system 1 comprises a control system 700 which typically is computerized and which typically comprises a database for keeping track of the bins 106.

Automated storage and retrieval systems as described above are typically constructed to be operated in areas at ambient temperatures, e.g. about 20° C. However, for some type of products optimal storage temperature may be different. For example, it may be desirable to store food at fridge temperature, typically between 1-4° C., or at freezer temperature, typically below −18° C. or below −20° C.

Furthermore, there may be situations to surround an automated storage and retrieval system with an atmosphere different from the ambient atmosphere, for example to create an inert atmosphere and/or an atmosphere with a specific humidity level and/or an atmosphere that reduces the risk of fire ignition by reducing the oxygen concentration in the surrounding atmosphere.

Automatic storage and retrieval systems having different temperature zones, and where the temperature can be controlled, are known. For example, patent publication WO 2015/124610 A1 describes a system for receiving and storing processed refrigerated and frozen food products using a plurality of container handling vehicles operated on a rail system. In this prior art solution, the bins are stacked below a common rail system in two different storage volumes separated by a wall. The container handling vehicles are allowed to freely move above the two storage volumes at an operating temperature such as room-temperature.

One disadvantage of this prior art solution is that a container handling vehicle is exposed for colder temperature when a bin at the colder zone is stored or retrieved. This may result in formation of condense, causing disturbances with electronics.

The prior art storage system described in WO 2019/001816 A1 shows a system with different temperature zones and means for transporting containers between the different temperature zones. In order to reduce temporary exposure of cold air onto the container handling vehicles, the solution comprises an elevator allowing lowering and raising of bins between an access point to a transfer zone.

However, this solution is complex and costly.

A storage facility where the oxygen concentration may be reduced in order to prevent start of fire is described in the article “WagnerImpulse” in the magazine “The Wagner Group Customer magazine” (March 2018). The low oxygen concentration is obtained by forcing oxygen-reduced air into the entire storage facility.

The article does not present any solutions for maintaining such a low oxygen concentration over a long time-span such as several days. For example, the article gives no indication of how the storage system may be operated to transport bins in or out of the storage system without increasing the oxygen concentration. Such an operation would necessitate frequent exposure of the storage system to atmospheric air.

It is an aim of the present invention to provide an automated storage and retrieval system and a method for operating such a system that solves or at least mitigates one or more of the aforementioned problems related to the use of prior art storage and retrieval systems.

It is also an aim of the present invention to provide solutions that allows handling of bins within a storage system located in a space having an environment different than the surrounding environment.

### SUMMARY OF THE INVENTION

The present invention is set forth and characterized in the independent claims, while the dependent claims describe other preferred/optional features.

In a first aspect, the invention concerns an automated storage and retrieval system comprising a first space, a second space, a wall separating the storage system into the first space and the second space, a container transfer passage extending through the wall and a container carrier arranged within the passage for transport of at least one storage container therethrough. The container transfer passage is suitable for holding and transferring storage containers between the first space and the second space and extends below a level of the rail system, preferably a level immediately below the rail system.

The storage and retrieval system may comprise a first storage volume arranged in the first space and allowing storage of storage containers in vertical stacks, a rail system arranged at least above where the storage containers would be stored; a first container handling vehicle configured to lift a storage container from the first storage volume, to transport the storage container along the rail system and to lower the storage container into the container transfer passage; and a container transporting device configured to lift the storage container from the container transfer passage and to transport the storage container to another location.

The rail system may comprise a first set of rails and a second set of rails oriented perpendicular to the first set of rails, the intersections of which rails form a grid of grid cells defining grid openings that allow the first container handling vehicle to lift and/or lower the storage containers therethrough. The rail system may continue into the second space.

The container carrier is arranged within the container transfer passage and is configured to support at least one storage container within the container transfer passage and to move within the container transfer passage between a first position within the first space and a second position within the second space of the automated storage and retrieval system.

The boundaries of the container transfer passage may be set up by a tunnel as further detailed below.

The first space may be an enclosed space, for example a space delimited by the wall, three other vertical walls, a roof and a floor, thereby enabling avoidance of unintentional thermal and/or gaseous leakage to or from the surroundings.

In an exemplary configuration, the container carrier is part of a container transfer apparatus which comprises parts to define a tunnel arranged defining the container transfer passage. The tunnel is configured to allow movements of the container carrier inside when transporting the at least one storage container between the first space and the second space. Further, the tunnel and the container carrier are configured such that, when the container carrier is arranged in at least one of the first position or the second position, the first space and the second space are closed off from each other. The container transfer passage thus has a vertical cross-sectional area allowing a storage container to be transported through by the container carrier.

The tunnel may comprise a mid frame portion extending through the wall. Such a mid frame portion may further comprise a roof aligned with, or near aligned with, the horizontal rail system. The mid frame portion may also comprise two vertical side walls oriented along the first set of rails.

The tunnel may also comprise a first frame portion arranged within the first space horizontally adjacent the mid frame portion and vertically below the rail system and a second frame portion arranged within the second space horizontally adjacent the mid frame portion. The mid frame portion, the first frame portion and the second frame portion are located vertically below the rail system. To allow transfer of storage containers into and out of the container transfer passage, each of the first and second transfer structures comprises an opening towards the rail system.

In another exemplary configuration, the container carrier comprises a carrier base for supporting a storage container and one or more carrier sides oriented parallel with a center plane of the wall and positioned at an edge of the carrier base. The container carrier may also comprise a seal arranged at an upper edge of the container carrier such that, when the container carrier is moving within the tunnel, the seal is contacting at least an upper part of the tunnel. For example, the seal may be extending around a least a portion of the carrier's perimeter. Alternatively, or in addition, such a seal may be coupled to the inside surface of the tunnel.

In yet another exemplary configuration, the container carrier and/or the tunnel is provided with thermal insulation material to reduce thermal conductivity in at least one position between the first space and second space through the container transfer passage. Examples of such thermal insulation material are polystyrene, fiberglass, mineral wool, cellulose and/or polyurethane foam

In yet another exemplary configuration, a width of the container carrier equals n times the width of the grid cell, wherein n is a positive integer.

In yet another exemplary configuration, the container carrier comprises transport means to allow horizontal movements of the container carrier between the first and second positions.

In yet another exemplary configuration, the container carrier comprises a carrier base for supporting a storage container and wherein the transport means comprises wheels or caterpillar belts arranged at or below the carrier base, thereby allowing the container carrier to move along the container transfer passage, for example along tracks.

In yet another exemplary configuration, the container carrier comprises a sensor configured to register a position of the container carrier relative to the container transfer passage/tunnel. The sensor may alternatively, or in addition, be arranged on the tunnel and may be in signal communication with the container carrier's transport means.

In yet another exemplary configuration, the transport means comprises wheels allowing the carrier to move along the container transfer passage/tunnel and the container transfer apparatus comprises tracks or rails extending between the first and second positions, wherein the tracks and/or the wheels is/are configured such that the wheels are guided by the tracks during movements.

In yet another exemplary configuration, the container transfer apparatus comprises a transmission belt extending between the first and second positions, a drive motor configured to rotate the transmission belt, tracks or rails extending between the first and second positions, wherein the tracks/rails and the transport means (for example wheels or caterpillar belts) are configured such that the transport means are guided by the tracks/rails when the drive motor is rotating the transmission belt.

In yet another exemplary configuration, the transmission belt of the container transfer apparatus is arranged below the carrier base within the container transfer passage.

In yet another exemplary configuration, wherein the container transfer apparatus comprises a power source configured to provide power to the drive motor. The power source may comprise a battery arranged on at least one of the container carrier and the tunnel. Alternatively, or in addition, the power source may comprise a power lead.

In yet another exemplary configuration, the rail system continues into the second space. Further, the container transporting device is in this configuration a second container handling vehicle configured to transport a storage container from the container transfer passage along the rail system in the second space.

In yet another exemplary configuration, the automated storage and retrieval system comprises a second storage volume contained within the second space and allowing storage of storage containers in vertical stacks. The container transfer passage thus extends through the wall between the first storage volume and this second storage volume. Further, the rail system extends above the second storage volume and/or the container transfer passage.

In yet another exemplary configuration, the container transfer passage and/or the tunnel is/are positioned such that a center plane of the wall intersects a centre plane of the container transfer passage/tunnel.

In yet another exemplary configuration, the container transfer passage is configured to hold a plurality of storage containers at the same time, for examples in stacks. In the latter case, any tunnel is arranged at the uppermost part of the container transfer passage. The container transfer passage is similarly increased in volume to accommodate multiple storage containers (and any increase in container carrier size)

In yet another exemplary configuration, the automated storage and retrieval system comprises a cooling unit configured to provide a temperature within the first space different than the temperature within the second space. Further, the wall may be provided with thermal insulation material to reduce thermal conductivity between the first and second spaces. As for the container carrier and/or the tunnel, the insulation material may for example be polystyrene, fiberglass, mineral wool, cellulose, polyurethane foam or a combination thereof. The particular configuration has the advantage of allowing storage of products for which the optimal storage temperatures may deviate from ambient temperature.

In a second aspect, the invention concerns container transfer apparatus for transfer of storage containers between a first space having a first temperature and a second space having a second temperature different from the first temperature. Alternatively, or in addition, the first space and the second space may have a first and a second gas/gas mixture and/or a first and a second pressure.

The container transfer apparatus may be configured as a separate unit that can be connected between the first storage volume and the second storage volume (for example as a retro fit).

Such a container transfer apparatus hence allows for transport of containers between spaces with different environments that is easy to install and maintain and ensures low or no thermal and/or gaseous leakage.

In the second aspect, the container transfer apparatus comprises a tunnel configured to allow transport of storage containers between the first space and the second space; and a container carrier arranged within the tunnel. The apparatus may also comprise drive means configured to allow controlled movement of the container carrier in the tunnel.

The container carrier and/or the tunnel may be provided with thermal insulation material to reduce thermal conductivity between the first space and the second space when installed in an automated storage and retrieval system of the first aspect of the invention. When installed, the tunnel extends through the wall.

In an exemplary configuration of the second aspect, the tunnel comprises a mid frame portion comprising a tunnel roof; a first frame portion arranged horizontally adjacent the mid frame portion; and a second frame portion arranged horizontally adjacent the mid frame portion opposite to the first frame portion. Each of the first and second frame portions comprises a horizontally extending opening to allow the storage containers to be lifted therethrough. The openings may be aligned with the tunnel roof of the mid frame portion to allow the storage containers to be lifted therethrough.

In another exemplary configuration of the second aspect, the container carrier comprises a seal arranged at an upper edge of the container carrier such that, when the container carrier is moving within the tunnel, the seal is contacting tunnel's inner boundaries, including an inside face of the tunnel roof. Alternatively, or in addition, such seals may be fixed to the inner boundaries.

In another exemplary configuration of the second aspect, the container carrier comprises a sensor configured to register a position of the container carrier relative to the tunnel. Alternatively, or in addition, such a sensor may be arranged on the tunnel.

In a third aspect, the invention concerns a method for transferring storage containers between a first space and a second space within an automated storage and retrieval system as described above for the first aspect of the invention.

The method may comprise the steps of:
moving the container carrier into the first space such that the first container handling vehicle may place a storage container into the container carrier;
lifting a storage container stored within the first storage volume using a lifting device constituting part of the first container handling vehicle;
transporting the storage container to a position directly above the container carrier using the container handling vehicle;
placing the storage container into the container carrier through a grid opening of the rail system using the lifting device;
moving the container carrier into the second space such that the storage container is accessible for the container transporting device;
lifting the storage container from the container carrier using the container transporting device; and
transporting the storage container to another location within the second space using the container transporting device.

In another exemplary process of the third aspect, the container transporting device is a second container handling vehicle configured to transport the at least one of the storage containers along the rail system. Further, the automated storage and retrieval system comprises a second storage volume contained within the second space and allowing storage of storage containers in vertical stacks. The transporting of the storage container to another location within the second space is performed along the rail system which extends into the second space above the second storage volume. Alternatively, or in addition, the container transporting device may be a crane.

In this exemplary process, the method may also comprise the step of placing the storage container onto a stack within the second storage volume.

In addition to solve or at least mitigate the problems described above and to provide solutions for allowing handling of storage containers within an automated storage and retrieval system located in a space having an environment different than the surrounding environment, at least some of the exemplary configurations have the additional advantage:
to provide an automated storage and retrieval system which allows safe long-term storage of biological species and/or fresh food;
to provide an automated storage and retrieval system which prevent condensation of electronics within container handling vehicles during transfer of storage containers between zones/spaces.
to provide an automated storage and retrieval system that significantly reduces the risk of a fire starting within or on the storage system during operation.

### BRIEF DESCRIPTION OF THE DRAWINGS

The following drawings depict embodiments of the present invention by way of example only and are appended to facilitate the understanding of the invention.

FIG. 1 is a perspective view of a prior art automated storage and retrieval system comprising a rail system onto which a plurality of remotely operated container handling vehicles is operating and a storage volume for storing stacks of storage containers.

FIG. 2 is a perspective view of a prior art remotely operating vehicle having a centrally arranged cavity for carrying storage containers therein.

FIG. 3 is a perspective view of a prior art remotely operating vehicle having a cantilever for carrying storage containers underneath.

FIG. 4 is a perspective view of a prior art remotely operating vehicle having an internally arranged cavity for carrying storage containers therein, wherein the cavity is offset from center relative to the X-direction.

FIG. 5 is a side view of an exemplary automated storage and retrieval system according to the invention, comprising a rail system onto which a plurality of remotely operated container handling vehicles is operating and two storage volumes for storing stacks of storage containers, wherein the two storage volumes are separated by a wall.

FIG. 6 is a perspective view of an exemplary automated storage and retrieval system according to the invention showing container handling vehicles, part of an exemplary container transfer apparatus and a wall separating the system in a first and a second space.

FIG. 7 is a perspective view of an exemplary automated storage and retrieval system according to the invention showing a container handling vehicle and part of an exemplary container transfer apparatus, where a carrier for transport of storage containers is arranged within a container transfer passage.

FIG. 8 is an exploded perspective view of a container transfer apparatus

FIG. 9 is a perspective view of an exemplary automated storage and retrieval system according to the invention, where FIG. 9A shows the carrier in position within a first space allowing a container handling vehicle in the first space to drop a storage container into the carrier and FIG. 9B shows the carrier in position within a second space allowing a container handling vehicle in the second space to pick up the storage container from within the carrier.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings. Furthermore, even if some of the features are described in relation to the storage system, the container transfer apparatus or the carrier only, it is apparent that they are valid for the related method as well, and vice versa.

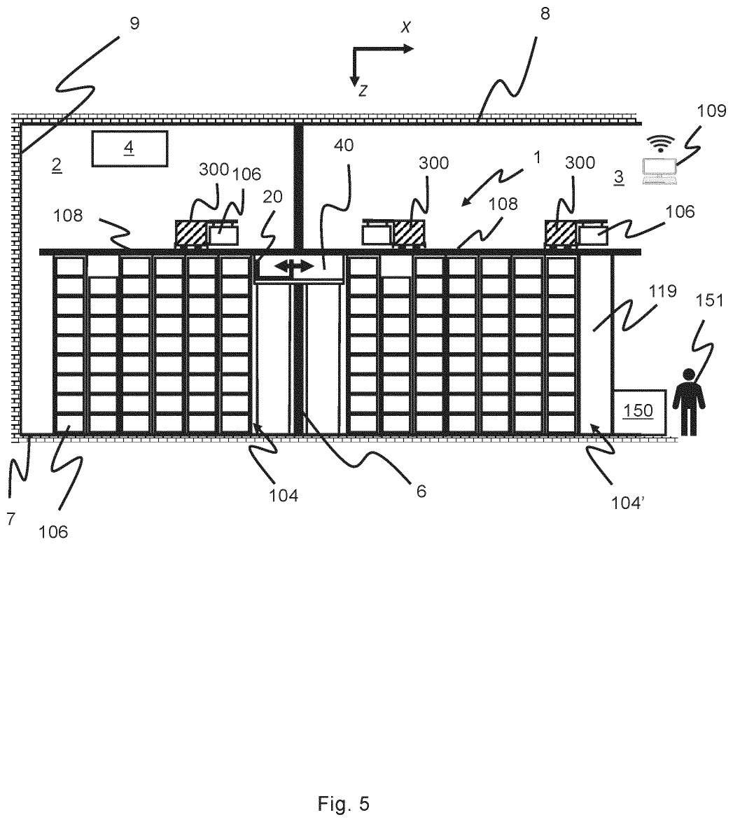

FIG. 5 shows a side view of an automated storage and retrieval system 1 according to the invention. Positive X, Y- and Z-directions are directed from left to right of the drawing, out of the drawing and from top to bottom of the drawing, respectively.

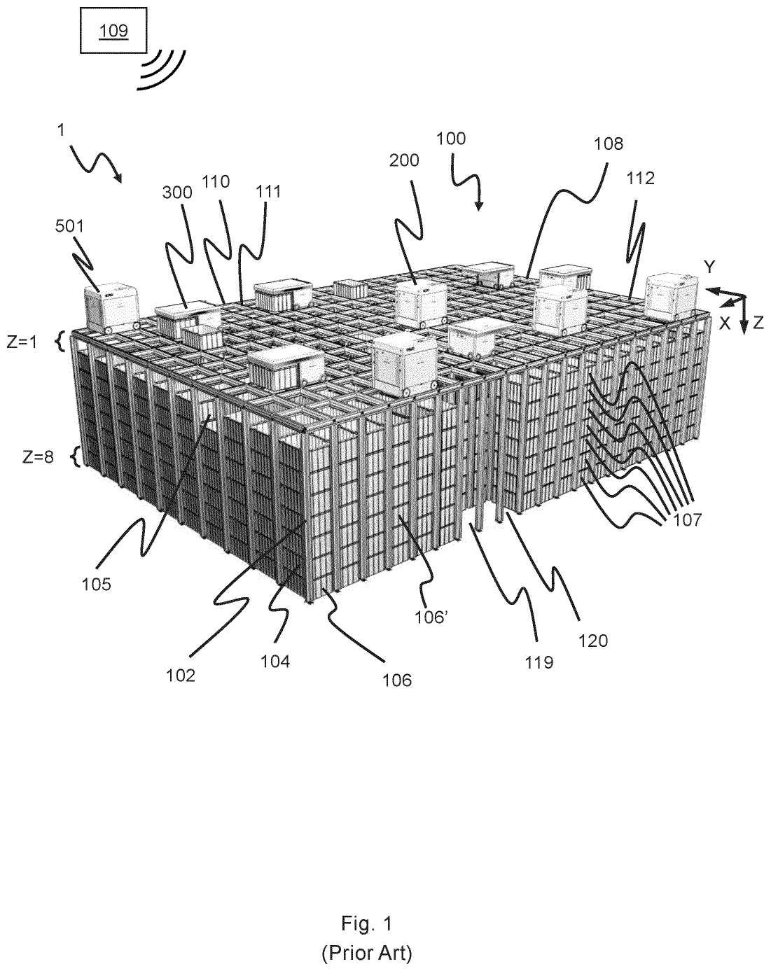

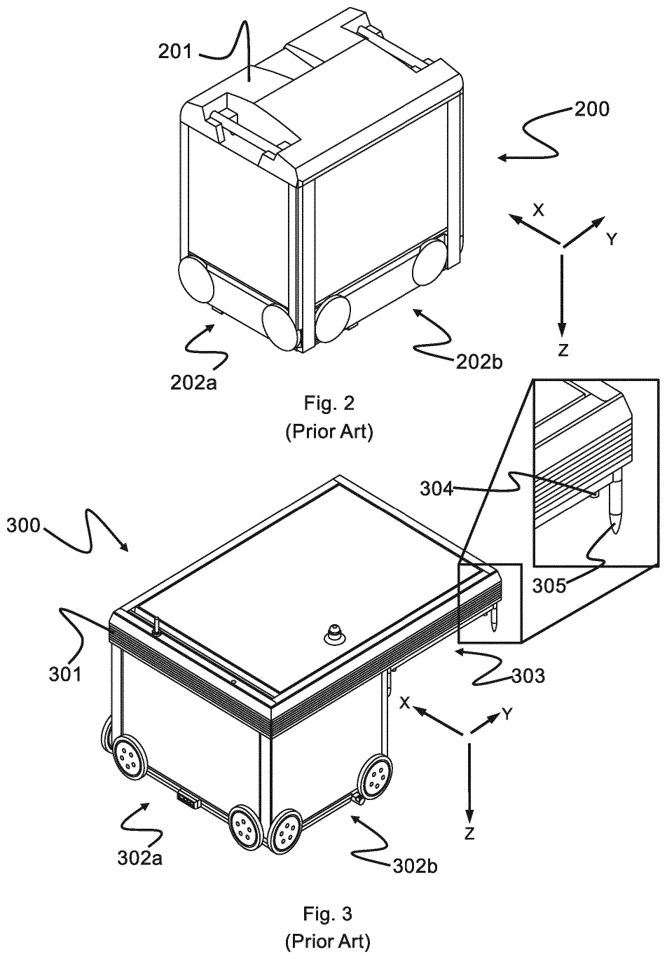

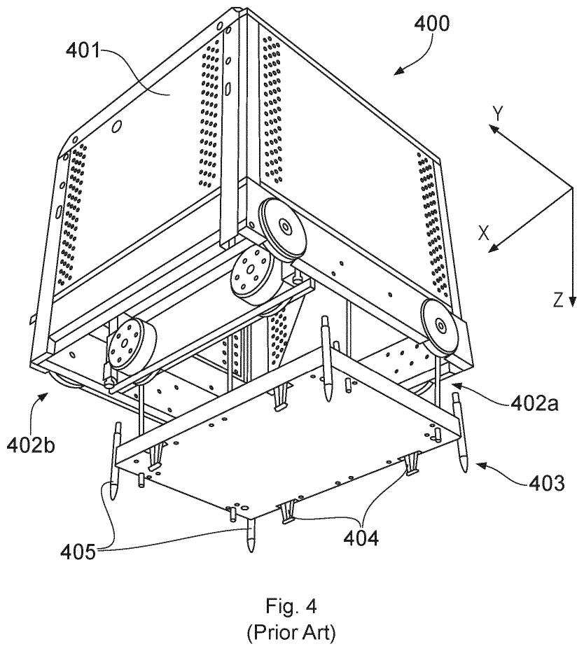

The inventive system 1 is divided into a first space 2 and a second space 3 by a separation wall 6 and a bin transfer passage 40 (container transfer passage). Both the first space 2 and the second space 3 contain a storage volumes 104,104′ having a common floor 7. The storage space set up by each storage volumes 104,104′ contains bins 106 (storage containers) in vertical stacks 107 as described in connection with the prior art system of FIG. 1.

A rail system 108 as described in connection with the prior art system of FIG. 1 extends above all three spaces 2,3,40. The part of the storage system 1 within the second space 3 also includes one or more port columns 119 for drop off or pick up of bins 106 to be transported to/from an access station 150. Further handling of bins 106 outside the storage system 1 may be performed by an operator 151 (robotic operator and/or human operator).

The bin transfer passage 40 is in FIG. 5 shown with a depth allowing one bin 106 only. However, the bin transfer passage 40 may be configured to accept a stack of bins 107 with a depth deeper than one bin 106, for example, a depth extending some (e.g., two or three) bin depths, or even all the way down to the common floor 7.

The separation wall 6 may comprise thermal isolating materials such as polystyrene, fiberglass, mineral wool, cellulose and/or polyurethane foam. Alternatively, or in addition, the separation wall 6 may comprise fireproof material to avoid, or significantly reduce, spread of fire between the first and second spaces 2,4. Examples of such fireproof materials are fire-resistant glass, concrete, gypsum, stucco and brick

The storage system 1 also include bin handling vehicles 300 (container handling vehicles) operating on top of the rail system 108 in both the first and the second space 2,3.

In the particular exemplary configuration shown in FIG. 5, the first space 2 contains a refrigerator 4 to enable cooling of the first space 2 to a temperature lower than the second space 3, for example to a temperature between 1-4 degrees centigrade or to a temperature below −18 degrees centigrade.

The bin transfer passage 40 is configured to allow pick-up and drop-off of bins 106 by the bin handling vehicles 300 from both sides of the wall 6, and is arranged through the first and second grid grids 104,104′, directly beneath the rail system 108.

In addition to the floor 7, the system 1 comprises a ceiling/roof 8, a second vertical wall 9 arranged opposite of the separation wall 6, and two additional front and back walls (not shown), thereby enclosing the first space 2.

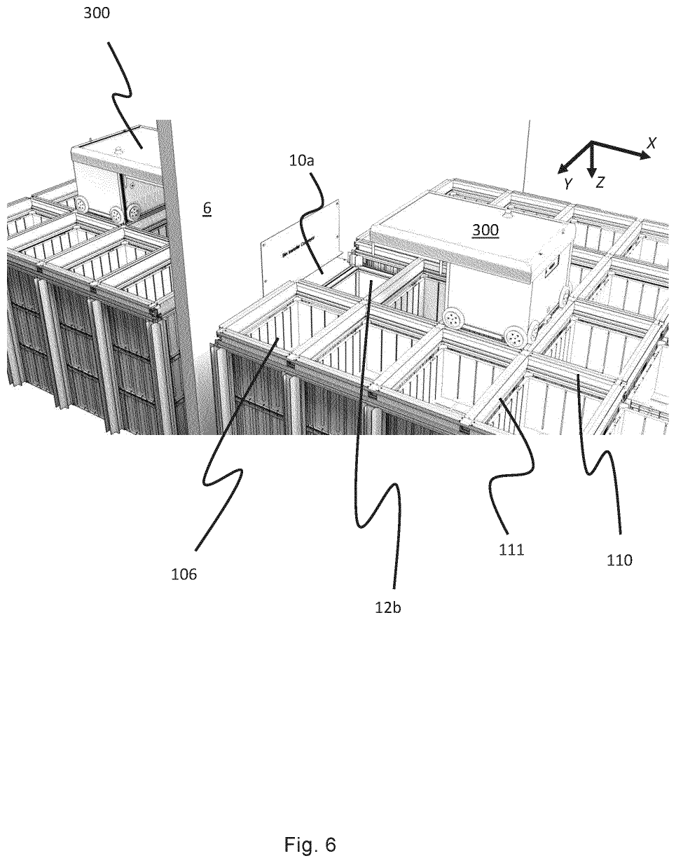

In order to enable transport of bins 106 through the bin transfer passage 40, a bin transfer system 10-12,20-26 (container transfer apparatus) is arranged within the bin transfer passage 40. With reference to FIGS. 6-8, the bin transfer system 10-12,20-26 comprises a tunnel 10-12 comprising a duct/mid frame portion/mid passage 10 centered with the position of the wall 6, a first frame portion 11 arranged adjacent the duct 10 and within the first space 2 and a second frame portion 12 arranged adjacent the duct 10 opposite of the first frame portion 11. The terms ‘centered’ and ‘adjacent’ are herein referring to positions relative to the X-direction in FIG. 5, i.e. horizontal/lateral direction perpendicular to the wall 6.

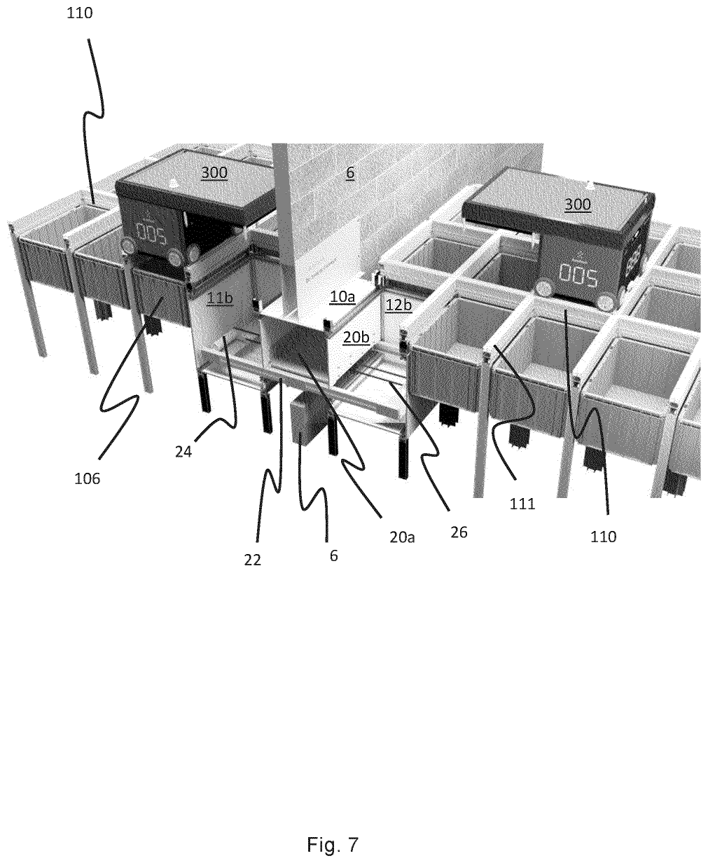

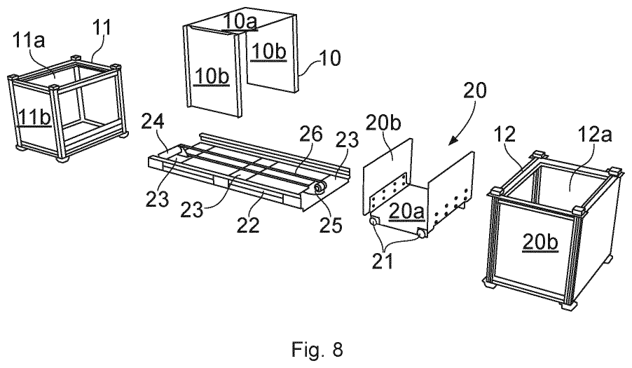

As best seen in FIGS. 7 and 8, the duct 10 may comprise a horizontal duct roof/tunnel roof 10a and two vertical duct walls/tunnel walls 10b aligned in the X-direction. Each of the first and second frame portions 11,12 may comprise an opening 11a, 12a towards a grid opening 112 within the rail system 108 to allow access for dropping/picking up bins 106 by the bin handling vehicles 300 and up to three vertical walls 11b, 12b to increase bin stability during operation while accepting bins 106 to be horizontally inserted via the duct 10.

The inner cross-sectional area of the tunnel(s) 10-12 oriented in the vertical plane (i.e. parallel to the orientation of the wall 6) is sufficiently large to allow bins 106 to be transported therein between the first space 2 and the second space 3.

As shown in FIGS. 5-9, the bin transfer system also comprises a bin carrier 20 having transport means in form of a plurality of wheels 21 and a carrier transporter 22-26 to enable controlled movements of the bin carrier 20 between the first and second spaces 2,3 through the bin transfer passage 40.

The carrier transporter 22-26 may comprise two carrier rails 22 extending along the tunnel 10-12, a plurality of base plates 23 connecting the two carrier rails 22 in a parallel orientation, a drive motor 24 fixed to an outer base plate 23 arranged at or near ends of the carrier rails 22, a rotation device 25 fixed at an outer base plate 23 at the opposite ends of the carrier rails 22 and a transmission belt 26 enclosing and contacting an drive motor axle of the drive motor 24 and the rotation device 25. The wheels 21 of the bin carrier 20 are placed within the two carrier rails 22 and the transmission belt is attached below a carrier base 20a of the bin carrier 20. Hence, when operating the drive motor 24, the drive motor axle rotates the transmission belt 26, thereby moving the bin carrier 20 between ends of the carrier rails 22. The direction of movement of the bin carrier 20 depends on the shaft's rotation direction.

The carrier transporter 22-26 may alternatively, or in addition, comprise carrier tracks 22 into which the wheels 21 are guided. Further, the wheels 21 may be replaced by other transport means such as sliding pads and/or caterpillar belts.

The plurality of base plates 23 may be replaced with a single base plate extending along the bin transfer passage 40. The tracks 22 may in this configuration be formed in the base plate. In advantage with this alter configuration is that low or no risk of thermal and/or gaseous leakage may be obtained between the bin transfer passage 40 and areas below.

With particular reference to FIG. 8, the carrier 20 may also comprise two or more vertical carrier walls 20b arranged at the edges of the carrier base 20a to increase stability of bins 106 during transport through the bin transfer passage 40.

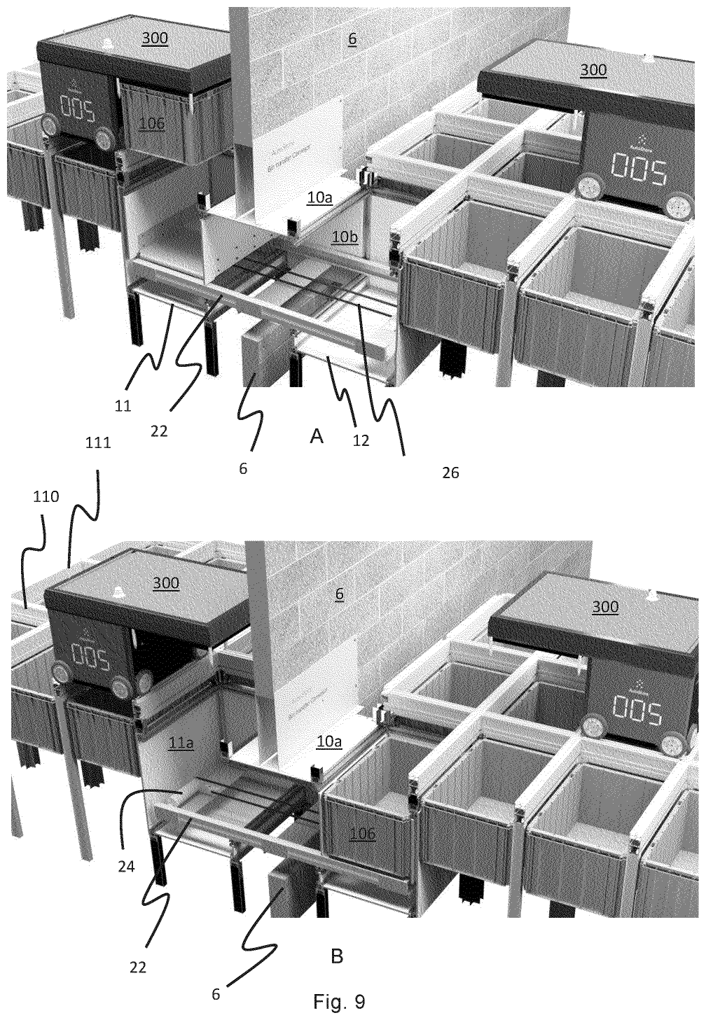

As seen in FIG. 7, when the carrier 20 is placed within the duct 10, i.e. centered with the wall 6 relative to the X direction, the first space 2 is isolated, or near isolated from the second space 3, thereby preventing, or at least significantly reducing, thermal and/or gaseous leakage. And as seen in FIG. 9, such isolating properties are fully or largely maintained also when the carrier 20 is moved into the first space 2 (FIG. 9A) and into the second space 3 (FIG. 9B).

Hence, during the entire transport operation of bins 106 between the first space 2 and the second space 3, there are no or at least significantly reduced thermal and/or gaseous leakage.

In FIGS. 7 and 9, one of the two side walls 10b-12b of the duct 10, the first frame portion 11 and the second frame portion 12 have been removed to better illustrate the tunnel's inner volume.

In FIG. 9A, the bin carrier 20 has been moved to the end of the bin transfer passage 40 below a grid opening 112 of the first storage volume 104 located within the first space 2 horizontally adjacent to the wall 6. Due to the above mentioned opening 11a in the first frame portion 11 of the tunnel 10-12, a bin handling vehicle 300 may lower a bin 106 onto the carrier base 20a through the grid opening 11a. By activating the drive motor 24, the transmission belt 26 transports the bin carrier 20 with the bin 106 via the duct 10 into the second frame portion 12 at the opposite end of the bin transfer passage 40. Due to the opening 12a in the second frame portion 12, a bin handling vehicle 300 may raise the bin 106 through a grid opening 112 of the second storage volume 104′ located within the second space 3 adjacent the wall 6.

To allow transport of bins 106 from the second space 3 to the first space 2, the opposite procedure may be performed.

In the particular example shown in FIGS. 6, 7 and 9, the bin transfer passage 40 is of a size corresponding to one grid cell along the Y direction (i.e. horizontal and parallel to the wall 6). The width of the tunnel 10-12 is in this example thus equal or slightly wider than one grid cell. In the X direction (i.e. horizontal and perpendicular to the wall 6), the bin transfer passage 40 is about three grid cells, thus allowing bins 106 to be placed/picked up through grid openings 112 adjacent to the wall 6. Note however that the bin transfer passage 40 may be of any size in the X and Y directions which allows accommodation of one or more bins and may be of any depth (i.e. in the Z direction). If the bin receiving space 40 is extended in the Y direction (width) and/or the X direction (length), the size of the tunnel 10-12 is extended accordingly.

At least part of the outside surfaces of the carrier 20 and/or at least part of the inside surfaces of the tunnel 10-12 may comprise seals (not shown) to further reduce any thermal and/or gaseous leakage between the first and second spaces 2,3. Moreover, in order to allow monitoring of the carrier's 20 position relative to the tunnel 10-12 and/or the rail system 108, the carrier 20 may comprise a sensor system (not shown).

Effective sealing between the bin carrier 20 and the tunnel 10-12 (and in addition or alternatively towards the rail system 108) may be achieved using different type of seals, for example rubber seals or brush seals. In order of increasing effectiveness of the sealing, the inner cross sectional size of the tunnel 10-12 (i.e. in the X-Z plane) should be adapted to the corresponding outer cross sectional size of the bin carrier 20 so that contact is achieved at the interface.

As for the wall 6, the carrier 20 and/or the tunnel 10-12 may comprise thermal isolating materials such as polystyrene, fiberglass or polyurethane foam if the intention of the storage system 1 is to maintain the first space 2 and the second space 3 at different temperatures.

If the intention is fire protection, fire-proof materials may be included into one or more of the space dividing components (wall 6, carrier 20, tunnel 10-12). Examples of fireproof materials that may be used are fire-resistant glass, concrete, gypsum, stucco and/or brick.

The carrier 20 and/or the tunnel 10-12 and/or the carrier transporter 22-26 may further comprise a controller (not shown) in signal communication with the drive motor 24. Such controller may be in wireless signal communication with the control system 109 controlling the bin handling vehicles 300 on the rail system 108.

The sensor system typically comprises two position sensors arranged on both sides of the carrier 20 relative to the X direction, thereby allowing monitoring of the positions of the carrier 20 relative to external structures such as the above arranged rail system 108 and/or the tunnel 10-12. The position sensors may be in signal communication with each other through a sensor wire and further in signal communication with the controller.

When the intention of the storage system 1 is to maintain a temperature within the first space 2 different from the temperature within the second space 3, for example, that the first space 2 is a chilled space (at or below 4 degrees centigrade) and the second space 3 is an ambient space (around 25 degrees centigrade), the carrier 20 and/or the tunnel 10-12 may also comprise temperature sensors, thereby allowing real-time monitoring of the temperature difference. This again would allow swift detection of undesired temperature equalization through the bin transfer passage 40 during bin transfer, for example, due to a damaged seal. Such temperature sensors may be in signal communication with the control system 109.

In order to at least reduce the risk of fire within the first space 2, the storage system 1 may be equipped with a gas regulating device (not shown). The gas regulating device may comprise a gas container located outside the first space 2, a gas inlet going into the first space 2 and a gas tube in fluid communication between the gas container and the gas inlet. With this arrangement, gas is allowed to flow between the gas container and the first space 2.

The gas container may comprise means for reducing a percentage of a gas element in a gas mixture, such as O₂ gas in air. Such means are known in the art and will thus not be explained further herein.

In dry air, the concentration of the flammable gas oxygen is about 21%. If the oxygen concentration is lowered to 16% or below, the risk of fire is significantly reduced. In air, a fire may potentially occur in theory, for example, due to sparks from the movements of the bin handling vehicles 300 and/or sparks from the charging stations (not shown) for charging the batteries within the vehicles 300 and/or combustion of contents within bins 106 and/or accidental heating such as may be caused by sunlight hitting flammable material within the storage system 1.

The gas-tight separation between the first space 2 and the second space 3 ensures that the bin handling vehicles 300 may store and fetch bins 106 located within an oxygen reduced atmosphere that has a reduced or insignificant risk of fire, but which may represent a health risk for humans, and to receive and deliver bins 106 to a workspace in which humans may safely work.

Another example of a range of use for a storage system 1 allowing control of gas concentration is storage of fresh food. Prior art tests have shown that that fruits such as apples may be best long-term stored in an atmosphere comprising 1% O₂ and 1-2.5% CO₂. The O₂ gas may be replaced with N₂ gas. The storage system 1 may with advantage be used in vertical farming applications.

A storage system 1 having both a cooling facility for cooling the first space 2 to temperatures below 10° C. and a gas regulating device, may create near ideal condition for storage of fresh food.

This fresh food configuration of the storage facility may be supplemented by a fire extinguishing device to decrease fire hazards.

To further reduce the complexity, the carrier 20 may alternatively be equipped with a dedicated motor (not shown) having an internal motor controller. A programmable logic controller (PLC) sends instructions to the motor for direction and speed. The sensor system sends instructions to the motor to stop the carrier 20 when it arrives to an end position (for example when the opening 11a, 12a of the first or second frame portion 11,12 are aligned with the grid opening 112 of the above rail system 108.

In the preceding description, various aspects of the automated storage and retrieval system, the container transfer apparatus and the method according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

### LIST OF REFERENCE NUMERALS/LETTERS

1 Automated storage and retrieval system
2 First space/chilled space
3 Second space/ambient space
4 Cooling system/refrigerator
6 Separation wall/wall
7 Floor
8 Ceiling/Roof
9 Second vertical wall/External wall
10 Duct/mid frame portion/mid passage
10a Tunnel roof/duct roof/upper part
10b Tunnel wall/duct wall
11 First frame portion of tunnel
11a Opening/first frame portion opening
11b Vertical wall/first frame portion wall
12 Second frame portion of tunnel
12a Second frame portion opening
12b Vertical wall/second frame portion wall
20 Bin carrier/carrier
20a Carrier base
20b Carrier wall
21 Transport means/wheels
22 Carrier rails or tracks
23 Base plate
24 Drive motor
25 Wheel mount/rotation device
26 Transmission belt
40 Container transfer passage/bin transfer passage
100 Framework structure
102 Upright members within storage volume
103 Horizontal members within storage volume
104 First storage volume
104′ Second storage volume
105 Storage column
106 Container/storage container/bin
106′ Particular position of a container/target container/target bin
106″ Vacant storage space for a container/bin
107 Stack
108 Rail system
109 Control system
110 Parallel rails in first direction (X)
111 Parallel rail in second direction (Y)
112 Grid opening
119 First port column/drop-off column
120 Second port column/pick-up column
150 Access station
151 Operator
200 Prior art container handling device/remotely operated vehicle with central cavity
201 Handling device body/Vehicle body
202a Transport means in first direction (X)
202b Transport means in second direction (Y)
300 Prior art container handling vehicle/remotely operated vehicle with cantilever/bin handling vehicle
301 Handling device body/Vehicle body
302a Transport means/wheel arrangement, first direction (X)
303b Transport means/wheel arrangement, second direction (Y)
303 Lifting device
304 Gripper element
305 Guiding pin
400 Prior art container handling device/remotely operated vehicle with offset cavity
401 Handling device body/Vehicle body
402a Transport means/wheel arrangement, first direction (X)
402b Transport means/wheel arrangement, second direction (Y)
403 Lifting device
404 Gripper element
405 Guiding pin
X First direction
Y Second direction
Z Third direction

1. An automated storage and retrieval system comprising:
a first space and a second space;
a first storage volume arranged in the first space and allowing storage of storage containers in vertical stacks,
a rail system arranged above where the storage containers would be stored;
a container transfer passage for transferring storage containers between the first space and the second space, the container transfer passage extending below a level of the rail system;
a wall separating the first space from the second space, and
a container carrier configured to move within the container transfer passage between a first position within the first space and a second position within the second space of the automated storage and retrieval system.

2. The automated storage and retrieval system according to claim 1, wherein the container carrier is part of a container transfer apparatus which comprises parts to define a tunnel for moving the container carrier inside when transporting the at least one storage container between the first space and the second space,
wherein the tunnel and the container carrier are configured such that, when the container carrier is arranged in at least one of the first position or the second position, the first space and the second space are closed off from each other.

3. The automated storage and retrieval system according to claim 2, wherein the container carrier comprises:
a carrier base for supporting a storage container,
a carrier side oriented parallel with a center plane of the wall and at an edge of the carrier base, and
a seal arranged at an upper edge of the container carrier such that, when the container carrier is moving within the tunnel, the seal is contacting an upper part of the tunnel.

4. The automated storage and retrieval system according to claim 1, wherein the container carrier is provided with thermal insulation to reduce thermal conductivity between the first space and the second space through the container transfer passage.

5. The automated storage and retrieval system according to claim 1, wherein the container carrier comprises transport means to allow transport of the container carrier between the first and second positions.

6. The automated storage and retrieval system according to claim 5, wherein the container carrier comprises a carrier base for supporting a storage container and wherein the transport means comprises wheels arranged at or below the carrier base.

7. The automated storage and retrieval system according to claim 5, wherein the transport means comprises wheels,
wherein the automated storage and retrieval system comprises:
tracks extending between the first and second positions,
wherein the tracks and the wheels are configured such that the wheels are guided by those tracks during movements.

8. The automated storage and retrieval system according to claim 5,
wherein the automated storage and retrieval system comprises:
a transmission belt extending between the first and second positions,
a drive motor configured to rotate the transmission belt, and
tracks extending between the first and second positions,
wherein the tracks and the transport means are configured such that the transport means are guided by the tracks when the drive motor is rotating the transmission belt.

9. The automated storage and retrieval system according to claim 8,
wherein the container carrier comprises a carrier base for supporting a storage container, and
wherein the transmission belt is arranged below the carrier base within the container transfer passage.

10.-15. (canceled)

16. The automated storage and retrieval system of claim 1, further comprising:
a first container handling vehicle configured to lift a storage container from the first storage volume, to transport the storage container along the rail system and to lower the storage container into the container transfer passage, wherein the rail system comprises a first set of rails and a second set of rails oriented perpendicular to the first set of rails, the intersections of which rails form a grid of grid cells defining grid openings that allow the first container handling vehicle to lift and/or lower the storage containers therethrough; and
a container transporting device configured to lift the storage container from the container transfer passage and to transport the storage container to another location.

17. The automated storage and retrieval system of claim 16, wherein the rail system continues into the second space; and wherein the container transporting device is a second container handling vehicle configured to transport a storage container from the container transfer passage along the rail system in the second space.

18. The automated storage and retrieval system of claim 17, further comprising a second storage volume contained within the second space and allowing storage of storage containers in vertical stacks; wherein the container transfer passage extends through the wall between the first storage volume and the second storage volume.

19. The automated storage and retrieval system of claim 1, wherein the automated storage and retrieval system comprises a cooling unit configured to provide a temperature within the first space different than the temperature within the second space; wherein the wall is provided with thermal insulation to reduce thermal conductivity between the first and second spaces.

20. A container transfer apparatus for transfer of storage containers between a first space having a first temperature and a second space having a second temperature different from the first temperature, wherein the container transfer apparatus comprises:
a tunnel configured to allow transport of storage containers between the first space and the second space;
a container carrier arranged within the tunnel; and
drive means configured to allow movement of the container carrier in the tunnel.

21. A method for transferring storage containers between a first space and a second space within an automated storage and retrieval system according to claim 16, wherein the method comprises:
moving the container carrier into the first space;
lifting a storage container stored within the first storage volume using a lifting device constituting part of the first container handling vehicle;
transporting the storage container to a position directly above the container carrier using the container handling vehicle;
placing the storage container into the container carrier using the lifting device;
moving the container carrier into the second space such that the storage container is accessible for the container transporting device;
lifting the storage container from the container carrier using the container transporting device; and
transporting the storage container to another location within the second space using the container transporting device.

22. The method according to claim 21, wherein the container transporting device is a second container handling vehicle configured to transport the at least one of the storage containers along the rail system; wherein the automated storage and retrieval system comprises a second storage volume contained within the second space and allowing storage of storage containers in vertical stacks; wherein the transporting of the storage container to another location within the second space is performed along the rail system; and wherein the method further comprises placing the storage container onto a stack within the second storage volume using a lifting device constituting part of the second container handling vehicle.
